(19) United States
(12) Patent Application Publication
(10) Pub. No.: US 2013/0050995 A1
(43) Pub. Date: Feb. 28, 2013

(54) LAMP CAPABLE OF GENERATING DRIVING ELECTRIC POWER FROM HEAT

(71) Applicant: Che-Jui HSU, Taipei (TW)

(72) Inventor: Che-Jui HSU, Taipei (TW)

(73) Assignee: Huang-Hsi HSU, Taipei (TW)

(21) Appl. No.: 13/585,148

(22) Filed: Aug. 14, 2012

(30) Foreign Application Priority Data
Aug. 24, 2011 (TW) 100215780

(51) Int. Cl. F21L 26/00

(52) U.S. Cl. 362/181

(57) ABSTRACT

The present invention is to provide a lamp capable of generating a driving electric power from heat, which includes a base portion provided therein with a receiving space for receiving a combustible substance (e.g., a gaseous fuel, kerosene, or a candle), a top portion connected above and spaced from the base portion, a thermoelectric cooling chip provided on the top portion and adjacent to the receiving space for converting the heat generated by burning the combustible substance into an induced current, a current stabilizer provided on the top portion (or the base portion) and connected to the thermoelectric cooling chip in order to receive the induced current and stably convert the induced current into a driving electric power, and a light-emitting element provided on the top portion (or the base portion) and connected to the current stabilizer so as to emit light upon receiving the driving electric power.

### FIELD OF THE INVENTION

The present invention relates to a lamp, more particularly to a lamp capable of converting heat generated by burning a combustible substance (e.g., a gaseous fuel, kerosene, or a candle) into a driving electric power through using a heat-to-electricity converter, so as to enable a light-emitting element to emit light upon receiving the driving electric power. Thus, the lamp can provide proper illumination even in places (e.g., a field or a park) where power supply devices (e.g., a socket) are absent, and the light-emitting ability of the lamp is effectively enhanced.

### BACKGROUND OF THE INVENTION

Recently, people's way of life has gradually changed with the development of economic and trade activities. In addition to pursuing material enjoyment, more and more emphasis is placed on the enhancement of the spiritual life. To relieve the stress built up from living in a concrete jungle, many people would go outdoors and engage in recreational activities such as hiking, camping, and cycling, so as to be relaxed both physically and mentally. The various recreational activities also provide tremendous business opportunities for the recreational industry. Camping, in particular, is very popular nowadays and is perfect for family members and friends because not only does it bring new experiences to our monotonous daily lives, but also the campers get to form a bond with one another through mutual help and cooperation. Many camping enthusiasts hold that camping is not complete without building a campfire and using candle lamps or kerosene lamps for lighting. These fuel-burning lamps provide warmth during chilly nights, double as insect repellers in summer nights, and add to the camping atmosphere more effectively than their electric counterparts. However, fuel-burning lamps are not bright enough when a strong light source is desired for illumination, and electricity-driven lamps (e.g., an electric lamp powered by a power cable or a flashlight powered by batteries) are usually called for in such cases.

If, in order to use electric lamps in camping, the campsite is deliberately located where electricity is available, the opportunity to get closer to the nature will be reduced, and the spirit of camping, compromised. If flashlights and no other lighting tools are used for illumination in camping, the ambience thus created will be less desirable than that by fuel-burning lamps, not to mention that the warmth and insect-repelling effect of the latter are lost, all of which deprive the campers of the leisurely atmosphere of camping. Moreover, it is difficult, if not impossible, to recharge a flashlight when the flashlight is carried around for a nighttime walk in the field. Should the batteries in the flashlight die during the walk, the user will lose the assistance of the lighting tool, which is dangerous. Therefore, the issue to be addressed by the present invention is to design a lamp configured for providing non-electricity-driven illumination and for automatically generating a driving electric power from a combustible substance so that, whenever a strong light source is needed, the driving electric power can drive a light-emitting element to give off light in addition to the non-electricity-driven illumination. Thus, proper lighting can be achieved even where power supply devices are not available.

### BRIEF SUMMARY OF THE INVENTION

In view of the fact that the enjoyment of nighttime outdoor activities is often impaired by the conventional fuel-burning lamps, which tend to produce insufficient light, and the conventional electric lamps, which fail to produce a leisurely camping atmosphere or a warming or insect-repelling effect, the inventor of the present invention conducted years of research and trials and finally succeeded in developing a lamp capable of generating a driving electric power from heat as disclosed herein. The disclosed lamp combines the advantages of fuel-burning lamps and electric lamps and further solves the power supply problem of the latter so as to provide proper illumination even where power supply devices are unavailable.

The first object of the present invention is to provide a lamp capable of generating a driving electric power from heat, wherein the lamp includes a base portion, a top portion, a heat-to-electricity converter, and a light-emitting element. The base portion is provided therein with a receiving space for receiving a combustible substance (e.g., a gaseous fuel, kerosene, or a candle). The combustible substance, when burning, generates both light and heat. The top portion is connected above and spaced from the base portion. The heat-to-electricity converter includes a thermoelectric cooling chip and a current stabilizer. The thermoelectric cooling chip is provided on the top portion and is adjacent to the receiving space. The thermoelectric cooling chip has one side serving as a heated side to be directly or indirectly heated by the heat generated by the combustible substance. The opposite side of the thermoelectric cooling chip serves as a heat dissipation side and is provided with a heat dissipation element (e.g., heat dissipation fins or a heat dissipation paste) for dissipating the thermal energy conducted from the heated side to the heat dissipation side. Thus, the temperature of the heat dissipation side is kept from varying significantly with the heat received by the heated side, and the temperature difference between the two sides of the thermoelectric cooling chip is hence increased or maintained so as for the thermoelectric cooling chip to generate an induced current out of the temperature difference. The current stabilizer is provided on the top portion or the base portion and is connected to the thermoelectric cooling chip in order to receive the induced current and stably convert the induced current into a driving electric power. The light-emitting element is provided on the top portion or the base portion and is connected to the current stabilizer so as to emit light upon receiving the driving electric power. Therefore, by means of the heat-to-electricity converter, the lamp can convert the heat generated by burning the combustible substance into the driving electric power, thereby driving the light-emitting element to emit light. Consequently, the light-emitting ability of the lamp is effectively enhanced. The lamp can provide proper illumination even in places (e.g., a field or a park) where power supply devices (e.g., a socket) are absent.

The second object of the present invention is to provide the foregoing lamp, wherein the lamp further includes a first switch. The first switch is provided on the top portion or the base portion and is connected between the current stabilizer and the light-emitting element so as to control the magnitude of the driving electric power input into the light-emitting element. By turning on or off or adjusting the first switch as needed, the light-emitting element can be turned on or off or adjusted to switch the lamp to a relatively bright or relatively dim lighting mode. This allows the lamp to provide not only the relatively dim lighting mode, in which the light is generated solely by burning the combustible substance, but also the relatively bright lighting mode, in which the first switch is turned on such that the light-emitting element, driven by the driving electric power from the current stabilizer, emits light in conjunction with the burning combustible substance. If applicable, the magnitude of the driving electric power transmitted from the current stabilizer to the light-emitting element can be controlled by adjusting the first switch, with a view to adjusting the current flowing through the light-emitting element and hence the brightness of the light-emitting element.

The third object of the present invention is to provide the foregoing lamp, wherein the lamp further includes a charging device. The charging device is electrically connected to the current stabilizer so as to receive the driving electric power. The charging device may be additionally and electrically connected to at least one electricity storage element (e.g., a battery) so as for the charging device to charge the at least one electricity storage element using the driving electric power and thereby generate a backup electric power. The at least one electricity storage element is electrically connected to the light-emitting element in order to provide the backup electric power thereto. The at least one electricity storage element can be charged while the combustible substance is burning to generate light. Once the combustible substance is used up, the at least one electricity storage element can supply the backup electric power to the light-emitting element, allowing the light-emitting element to continue emitting light.

The fourth object of the present invention is to provide the foregoing lamp, wherein the lamp further includes a motor and a rotating screen. The motor is provided on the top portion or the base portion and is electrically connected to the at least one electricity storage element so as to receive the backup electric power. The rotating screen corresponds in position to either of the light sources in the lamp. Thus, the light generated by the lamp can project outward through patterns or graphics on the rotating screen to form a projected image. Moreover, the rotating screen can be driven to rotate by the motor so that the projected image is rotatable with the rotating screen to produce a dynamic visual effect.

The fifth object of the present invention is to provide the foregoing lamp, wherein the lamp is further provided with a second switch. The second switch is connected between the at least one electricity storage element and the motor so as to control the backup electric power input from the at least one electricity storage element into the motor. Rotation of the motor can be activated or stopped by turning on or off the second switch.

The sixth object of the present invention is to provide the foregoing lamp, wherein the lamp is further provided with a transparent lampshade. The lampshade is provided between the top portion and the base portion and corresponds in position to the receiving space. In addition to diffusing the light generated by burning the combustible substance, the lampshade can prevent ambient air flow from interfering with the combustion of the combustible substance and keep the heat generated by the combustible substance from dissipation.

### BRIEF DESCRIPTION OF THE SEVERAL VIEWS OF THE DRAWINGS

The structure as well as a preferred mode of use, further objects, and advantages of the present invention will be best understood by referring to the following detailed description of some illustrative embodiments in conjunction with the accompanying drawings, in which:

FIG. 1 is a perspective view of a preferred embodiment of the present invention;

FIG. 2 is a sectional view of the embodiment shown in FIG. 1; and

FIG. 3 is a schematic drawing of another preferred embodiment of the present invention.

### DETAILED DESCRIPTION OF THE INVENTION

The inventor of the present invention has long been engaged in the research and development of products for use in outdoor recreation and entertainment. In the process, the inventor has found that outdoor activity enthusiasts often find it difficult to choose a nighttime lighting tool. While fuel-burning lamps can provide warmth, repel insects, and create a lighting ambience that seems capable of taking the users away from the hustle and bustle of their daily lives, these lamps fail to generate enough light when a strong light source is needed. If electric lamps are used instead, the relatively strong light they produce tends to compromise the atmosphere of an outdoor activity. Furthermore, the conventional electric lamps are not configured for providing warmth and repelling insects, and the use of electric lamps is very likely to limit the users' range of activity to where electricity is available. Even if an electric lamp is powered by batteries, it is practically impossible to recharge the lamp during a nocturnal excursion, in which case the lamp becomes useless once the batteries run out of power, and the failure of a nighttime lighting tool can be extremely dangerous. As such, the choice between fuel-burning lamps and electric lamps is a dilemma indeed. After repeated experiments, the inventor of the present invention finally succeeded in developing a lamp capable of generating a driving electric power from heat. This lamp not only combines the merits of a fuel-burning lamp and an electric lamp but also solves the power supply problem of the latter. Hence, the lamp disclosed herein can provide proper lighting even in places lacking power supply devices.

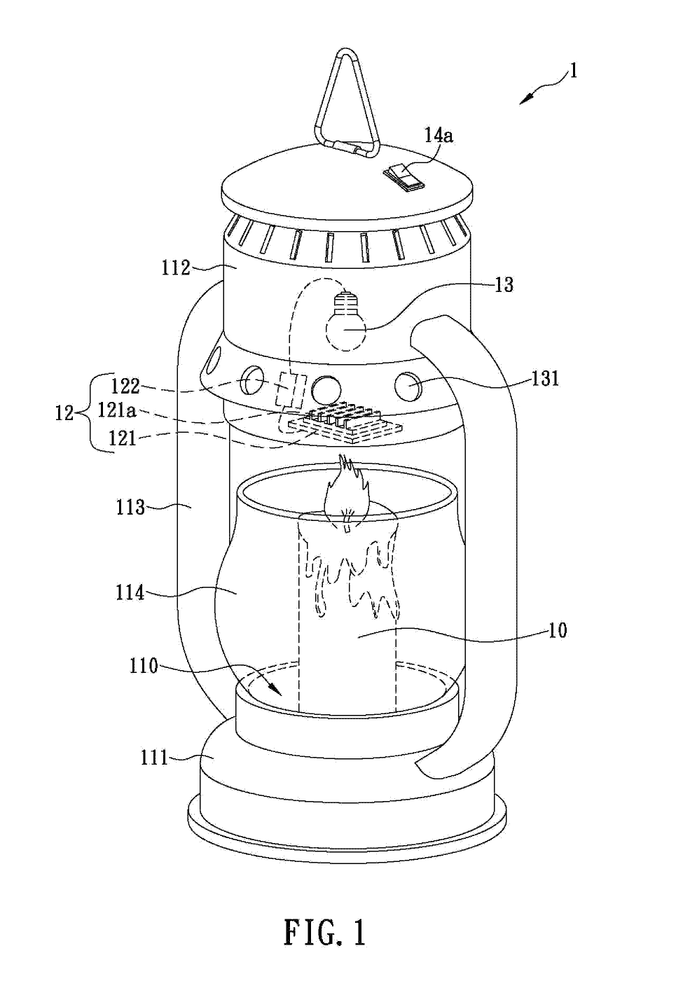

Please refer to FIG. 1 for a preferred embodiment of the lamp capable of generating a driving electric power from heat according to the present invention. The lamp 1 includes a base portion 111, a top portion 112, a heat-to-electricity converter 12, and a light-emitting element 13 (e.g., an ordinary lamp or a light-emitting diode (LED) lamp). The base portion 111 is provided therein with a receiving space 110 for receiving a combustible substance 10 (e.g., a gaseous fuel, kerosene, or a candle). The combustible substance 10 generates light and heat during combustion. The top portion 112 is connected above the base portion 111 and is spaced therefrom. In the lamp 1 shown in FIG. 1, the top portion 112 is connected to the base portion 111 by two supporting arms 113. In practice, however, the location and the manner of installation of the top portion 112 are not limited to the foregoing. The heat-to-electricity converter 12 includes a thermoelectric cooling chip 121 and a current stabilizer 122. The thermoelectric cooling chip 121 is fixedly provided on the top portion 112 and is adjacent to the receiving space 110. One side of the thermoelectric cooling chip 121 serves as a heated side to be directly or indirectly heated by the heat generated by the combustible substance 10. The opposite side of the thermoelectric cooling chip 121 serves as a heat dissipation side and is provided with a heat dissipation element 121a (e.g., heat dissipation fins or a heat dissipation paste) for dissipating the thermal energy conducted from the heated side to the heat dissipation side. Thus, the temperature of the heat dissipation side will not vary significantly with the heat received by the heated side. This helps increase or keep the temperature difference between the two sides of the thermoelectric cooling chip 121, allowing the thermoelectric cooling chip 121 to generate an induced current out of the temperature difference. In the lamp 1 of FIG. 1, the current stabilizer 122 is fixedly provided on the top portion 112. In practice, however, the location and the manner of installation of the current stabilizer 122 are not limited to the foregoing. For example, the current stabilizer 122 may be fixedly provided on the base portion 111 instead. The current stabilizer 122 is connected to the thermoelectric cooling chip 121 in order to receive the induced current and convert the induced current stably into a driving electric power. The light-emitting element 13 is provided on the top portion 112, but the location of the light-emitting element 13 is by no means limited thereto. For example, the light-emitting element 13 may be fixedly provided on the base portion 111 instead. The light-emitting element 13 is connected to the current stabilizer 122 so as to emit light after receiving the driving electric power. Either the top portion 112 or the base portion 111 is further provided with at least one light-permeable portion 131 (e.g., a piece of transparent or translucent glass). The at least one light-permeable portion 131 corresponds in position to the light-emitting element 13 so as for the light emitted by the light-emitting element 13 to project outward of the top portion 112 or the base portion 111. While the combustible substance 10 in the lamp 1 is burning and thereby generates light, the heat generated by the combustible substance 10 drives the thermoelectric cooling chip 12 to generate the driving electric power, which in turn drives the light-emitting element 13 to emit light. Thus, the light-emitting ability of the lamp 1 is effectively increased, and the lamp 1 can provide proper illumination even in places (e.g., an open field or a park) lacking power supply devices (e.g., a socket).

Referring again to FIG. 1, in another preferred embodiment of the present invention, a transparent lampshade 114 is provided between the top portion 112 and the base portion 111 and corresponds in position to the receiving space 110. The lampshade 114 can diffuse the light generated by burning the combustible substance 10, prevent the surrounding air flow from affecting the burning of the combustible substance 10, and keep the heat generated by the combustible substance 10 from dissipation.

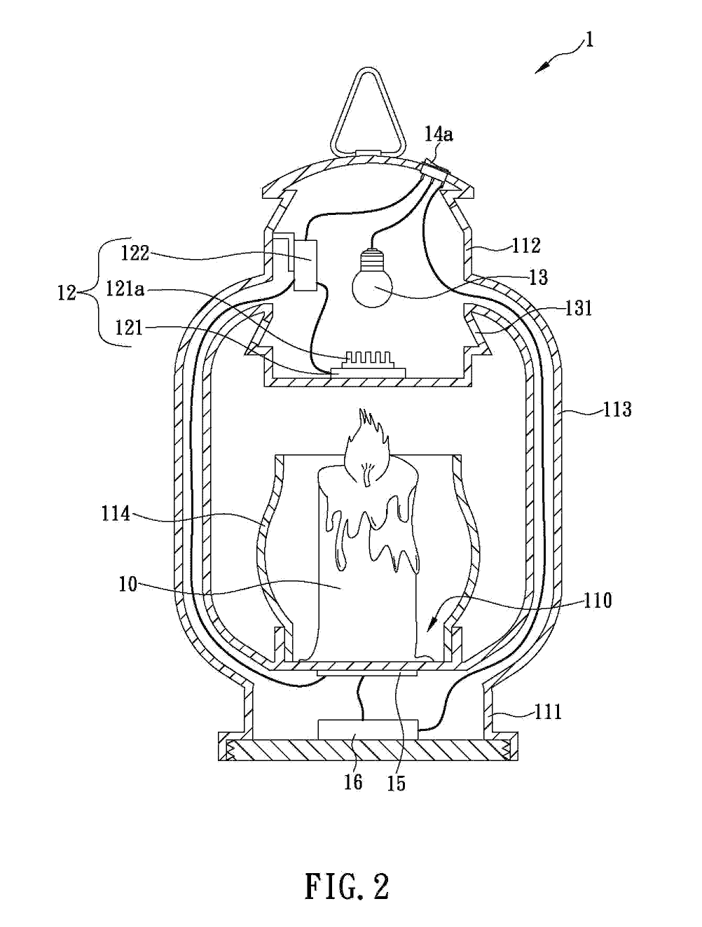

Referring to FIG. 2 for a sectional view of the embodiment shown in FIG. 1, the lamp 1 is further provided with a first switch 14a. The first switch 14a in this embodiment is fixedly provided on the top portion 112, and yet the location and the manner of installation of the first switch 14a are not limited to the foregoing. For example, the first switch 14a may be fixedly provided on the base portion 111 instead. The first switch 14a is respectively connected to the current stabilizer 122 and the light-emitting element 13 so as to control the driving electric power input from the current stabilizer 122 into the light-emitting element 13. By operating the first switch 14a, the light-emitting element 13 can be turned on or off as desired. More specifically, when the first switch 14a is opened (i.e., turned off), the lamp 1 enters a relatively dim lighting mode in which illumination is provided solely by the light generated by combustion of the combustible substance 10. When the first switch 14a is turned on to close the circuit between the current stabilizer 122 and the light-emitting element 13, the driving electric power provided by the current stabilizer 122 drives the light-emitting element 13 of the lamp 1 to emit light together with the combustible substance 10; thus, the lamp 1 enters a relatively bright lighting mode. Nevertheless, the operation of the first switch 14a is not limited to that described above. For example, the first switch 14a may be implemented by a turning knob with a variable resistance so that, by adjusting the first switch 14a, the driving electric power transmitted from the current stabilizer 122 to the light-emitting element 13 can be controlled to thereby control the brightness of the light emitted by the light-emitting element 13. In fact, the first switch 14a can be any device capable of turning on or off and/or adjusting the current through the light-emitting element 13 and thereby controlling the brightness of the light-emitting element 13.

Referring again to FIG. 2, the lamp 1 further includes a charging device 15 provided in the base portion 111. In practice, however, the location of the charging device 15 is not limited to the foregoing. For example, the charging device 15 may be fixedly provided on the top portion 112 instead. The charging device 15 is electrically connected to the current stabilizer 122 in order to receive the driving electric power. The charging device 15 is further electrically connected to an electricity storage element 16 (e.g., a rechargeable battery) so as for the charging device 15 to charge the electricity storage element 16 with the driving electric power and thereby generate a backup electric power. In this embodiment, the electricity storage element 16 is also provided in the base portion 111 and is electrically connected to the light-emitting element 13 either directly or through the first switch 14a in order to supply the backup electric power to the light-emitting element 13. When the first switch 14a is turned off, the supply of the backup electric power from the electricity storage element 16 to the light-emitting element 13 is cut off, and the lamp 1 operates in the relatively dim lighting mode, in which the lamp 1 generates light only by burning the combustible substance 10, and in which the heat generated by burning the combustible substance 10 is used to charge the electricity storage element 16 by way of the heat-to-electricity converter 12 and the charging device 15. The heat generated by the combustible substance 10 is thus converted into the backup electric power and stored in the electricity storage element 16. Once the combustible substance 10 is depleted, the first switch 14a can be turned on to close the circuit between the electricity storage element 16 and the light-emitting element 13, allowing the light-emitting element 13 to emit light using the backup electric power stored in the electricity storage element 16, so as for the lamp 1 to keep providing illumination.

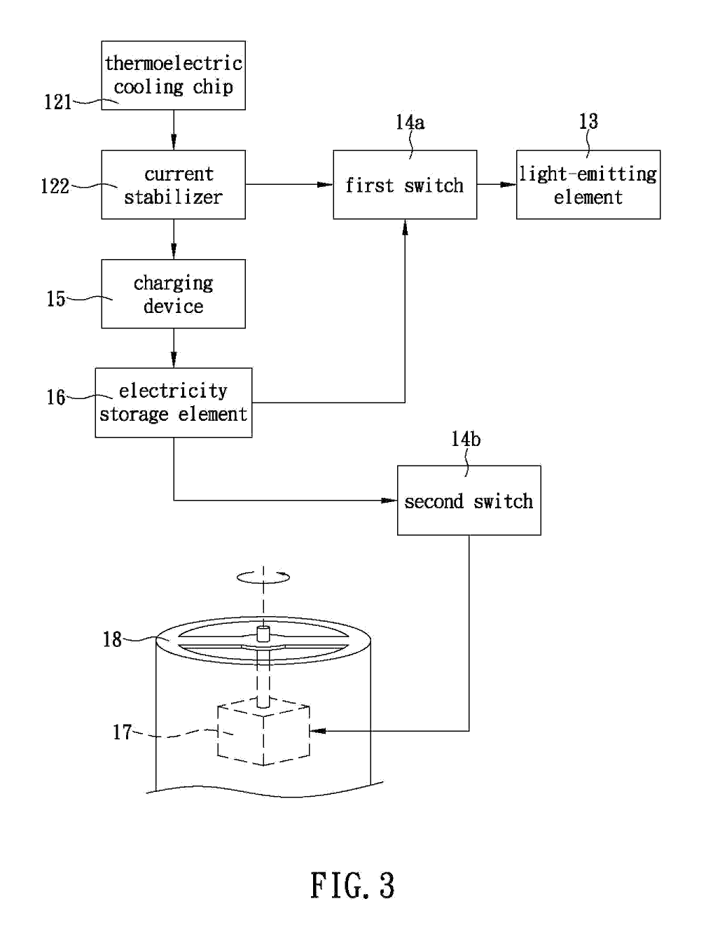

Referring to FIG. 3, in another preferred embodiment of the present invention, the lamp 1 further includes a motor 17 and a light-permeable screen 18. The motor 17 is provided on the top portion 112 or the base portion 111 (see FIG. 1) and is electrically connected to the electricity storage element 16 so as to receive the backup electric power. In addition, a second switch 14b provided between the motor 17 and the electricity storage element 16 can be used to turn on or off the supply of the backup electric power from the electricity storage element 16 to the motor 17. By turning on or off the second switch 14b, the motor 17 is driven to rotate or is stopped from rotation. The light-permeable screen 18 is connected to the rotating shaft of the motor 17 and can therefore rotate along with the motor 17. The light-permeable screen 18 is mounted around a periphery of the lamp 1 that corresponds to the light-emitting element 13 or the combustible substance 10 (see FIG. 1). Thus, the light generated by the light-emitting element 13 or the combustible substance 10 can project outward through patterns or graphics on the light-permeable screen 18 to form a projected image which, when the light-permeable screen 18 is driven to rotate by the motor 17, rotates with the light-permeable screen 18 to produce a dynamic visual effect.

While the invention herein disclosed has been described by means of specific embodiments, numerous modifications and variations could be made thereto by those skilled in the art without departing from the scope of the invention set forth in the claims.

What is claimed is:

1. A lamp capable of generating a driving electric power from heat, comprising:
a base portion provided therein with a receiving space for receiving a combustible substance, wherein the combustible substance generates light and heat during combustion;
a top portion connected above and spaced from the base portion;
a heat-to-electricity converter comprising a thermoelectric cooling chip and a current stabilizer, the thermoelectric cooling chip being provided on the top portion and adjacent to the receiving space, the thermoelectric cooling chip having a side to be directly or indirectly heated by the heat so as to generate an induced current, the current stabilizer being provided on the top portion or the base portion and connected to the thermoelectric cooling chip so as to receive the induced current and stably output a driving electric power; and
a light-emitting element provided on the top portion or the base portion and configured for receiving the driving electric power from the current stabilizer in order to emit light.

2. The lamp of claim 1, further comprising:
a charging device provided in the top portion or the base portion and electrically connected to the current stabilizer so as to receive the driving electric power; and
an electricity storage element provided in the base portion and electrically connected to the charging device so as for the charging device to charge the electricity storage element using the driving electric power, wherein the electricity storage element is also electrically connected to the light-emitting element so as to provide a backup electric power to the light-emitting element.

3. The lamp of claim 1, further comprising a first switch, wherein the first switch is connected between the light-emitting element and the current stabilizer and is configured for turning on or off or adjusting the driving electric power transmitted to the light-emitting element.

4. The lamp of claim 2, further comprising a first switch, wherein the first switch is connected between the light-emitting element and the current stabilizer or between the light-emitting element and the electricity storage element and is configured for turning on or off or adjusting the driving electric power or the backup electric power transmitted to the light-emitting element.

5. The lamp of claim 3, further comprising:
a motor provided in the top portion or the base portion and electrically connected to the electricity storage element so as to receive the backup electric power; and
a light-permeable screen provided on a rotating shaft of the motor and corresponding in position to the light-emitting element or the combustible substance.

6. The lamp of claim 4, further comprising:
a motor provided in the top portion or the base portion and electrically connected to the electricity storage element so as to receive the backup electric power; and
a light-permeable screen provided on a rotating shaft of the motor and corresponding in position to the light-emitting element or the combustible substance.

7. The lamp of claim 5, further comprising a second switch, wherein the second switch is connected between the electricity storage element and the motor and is configured for turning on or off rotation of the motor.

8. The lamp of claim 6, further comprising a second switch, wherein the second switch is connected between the electricity storage element and the motor and is configured for turning on or off rotation of the motor.

9. The lamp of claim 7, further comprising a transparent lampshade, wherein the transparent lampshade is provided between the top portion and the base portion and corresponds in position to the receiving space.

10. The lamp of claim 8, further comprising a transparent lampshade, wherein the transparent lampshade is provided between the top portion and the base portion and corresponds in position to the receiving space.
